(19) United States
(12) Patent Application Publication
(10) Pub. No.: US 2002/0084699 A1
(43) Pub. Date: Jul. 4, 2002

(54) Apparatus for controlling electrical loads of a bathing appliance

(76) Inventor: William Harry Kemp, Clayton (CA)

Correspondence Address: Sequence Controls Inc., 150 Rosamond Street, Carleton Place, ON, K7C 1V2, CA

(21) Appl. No.: 10/011,395

(22) Filed: Dec. 11, 2001

Related U.S. Application Data
(60) Provisional application No. 60/256,927, filed on Dec. 21, 2000.

(51) Int. Cl. H01H 1/00

(52) U.S. Cl. 307/112

(57) ABSTRACT

An apparatus operable in a wet environment, for controlling the flow of electrical current to an electrical load, adapted to be coupled to an AC source for supplying an AC signal. Includes a switching device coupled to the electrical load, the switching device being operative in either a first state wherein significant current flow through the load is prevented or a second state wherein current flow through the load is substantially undisturbed. An interconnection means is adapted to be coupled to an AC source and electrical load, wherein the interconnection means allows for plug and receptacle connection to the AC source and electrical load, respectively. Also includes a telemetry receiver for receiving user input signals from a transmitter to determine the operating status of the switching device. A controller receives the switching device status signals from the radio receiver and is used for switching the switching device between its first and second states in a predetermined sequence. A power supply is adapted to be coupled to the AC source for supplying low voltage, direct current to the controller and radio receiver. Includes an isolation means for electrically isolating the user input signals from the AC source, wherein the isolation means includes a telemetry receiver for coupling the user input signals to the controller.

### RELATED APPLICATIONS

The applicant claims priority of provisional application 60/256927, filed Dec. 21, 2000.

### FIELD OF THE INVENTION

The present invention relates generally to an apparatus used for the control of electrical loads of a bathing appliance. More particularly, the present invention relates to a controller coupled to a switching means, radio receiver device for the detection of telemetry data related to controlling the status of electrical pumps and loads of a bathing appliance, for use in a wet, electrically hazardous environment.

### BACKGROUND OF THE INVENTION

Bathing appliances such as hot tubs, swimming pools, shower units and hydromassage bath fixtures employ a means to control the flow of electrical energy to pump motors, air blower, heaters, lights and other loads, associated with their use. The prior art means of providing this control may be very simple, for example a wall mounted switch or mechanical timer may be utilised to turn the circulation pump on and off.

Regardless of the means employed for this control function, it is of primary importance to ensure that there is no possibility of the bather, touching an electrically live switching or control means. Those readers skilled in the art will realise that there is a high likelihood of electrical shock hazard when a source of A.C. mains power is accessible to a bather submersed in essentially, conductive, grounded water. The prior art utilises many means of providing electrical, mechanical or a combination of both insulation systems to prevent shock hazard. For example, a simple wall switch or mechanical timer may be mounted a sufficient distance away from the bather. This will necessitate the bather stepping out of the bath water, to activate the control to start or stop the pump, or other electrical load.

One common type of prior art control system, utilises a pneumatic isolation means for allowing the bather to remain in the bath water and control the pump load. In this type of system, a water proof, actuation “air bellows” style of button is mounted on the rim of the subject bathing appliance, accessible to the bather. A length of air hose is connected to the bellows, with the opposite end connected to an air pressure activated switch. The switch is series coupled between the pump motor or other electrical load of the bathing appliance and a source of AC mains supply. When the subject bather operates the “air bellows switch”, air pressure is coupled through the hose to the switch, causing it to operate. The switch will toggle between conducting and non-conducting states on alternate operations, opening or closing the source of AC mains supply to the load. Such systems have been installed for many years and provide a useful, low cost means of operating the bath while immersed in the bathing water.

Prior art control systems are also known to utilise electrical isolation means for controlling the electrical loads of the bath appliance. In this type of system an electrical push button, touch pad or similar electrical actuator means is mounted on the rim of the bath appliance. The button is coupled to a controller means by conductive cable. The controller means is coupled to a source of AC mains supply through a step-down, isolation transformer. The controller means is also coupled to a switching means, which is coupled in series between the AC mains supply and the electrical load of the bathing appliance. The combination of coupling the controller means to the step down transformer and switching means, provides sufficient electrical isolation to allow an electrical switching means to be made accessible to the user of the bathing appliance. Whenever the button means is activated by the bather, the controller means signals the switching means which will toggle between conducting and non-conducting states on alternate operations, opening or closing the source of AC mains supply to the load. This type of electrical isolation, control system may provide additional functions that are difficult to implement in the pneumatic control means described above. For example, the controller means could provide timing signals to the switching means, thereby allowing the electrical load to operate for a given period of time. Similarly, the switching means could include a thyristor means and receive phase angle control signals from the controller means, by way of the user button means. Such an implementation could for example, provide variable speed function to universal motor loads, or light dimming control of bathing appliances so equipped. A further advantage of a wired coupled button means, is that status lights, water temperature and programmable timer displays may be added without difficulty. A person skilled in the art will be familiar with thyristors, phase angle control, universal motors and advanced displays, included in such a system.

A drawback with pneumatic control devices is that they are difficult to design with sufficient control features such as variable speed functions or user displays. For this reason, pneumatic controls are typified as “low quality” and are delegated to inexpensive products at the “introductory sales end” of a manufacturers market.

While electrically isolated control systems provide sufficient features, they require the use of electrical cables between the AC mains supply, electrical load(s) and between the button and controller means. Although this is the accepted installation provided in the prior art, it would be a desirable feature to eliminate these wiring connections. Wire connections require skilled electricians to provide proper and safe installation. Further, once installed, the wire cables used to provide the installation are often located in areas where access is difficult, making future servicing a costly problem. Additionally, step down, isolation transformers and other electrical isolation means utilised within these controls increase the size and cost of the control system.

Accordingly, it is an object of the present invention to provide a control system for bathing appliances such as hot tubs, swimming pools, shower units and hydromassage bath fixtures, wherein the control system requires no specialised skills for installation, enabling homeowners or those persons, not necessarily skilled in electrically wiring, able to install and service the controller system.

It is a further object of the present invention to eliminate the interconnection cables and associated wiring used in the prior art. One preferred embodiment of the present invention contemplates the bather using a radio transmitter to signal a radio receiver within the control system and provide electrical load control signals to the controller and switching means. A person skilled in the art would understand that other telemetry means could be employed, such as infrared light modulation, without departing from the scope of the present invention.

### SUMMARY OF THE INVENTION

To protect the bather from electric shock, the electrical energy driving the controller means and electrical load is sufficiently isolated from the bather user control by use of a telemetry signal.

According to an aspect of the invention, there is provided an apparatus operable in a wet environment for operating an electrical load adapted to be coupled to an AC source for supplying and AC signal comprising:

an interconnection means adapted to be coupled to an AC source and electrical load, wherein the interconnection means allows for plug and receptacle connection to the AC source and electrical load, respectively;

a switching device adapted to be coupled in series with the interconnection means, wherein the switching device is operable in either a first state wherein significant current flow through the electrical load is prevented or a second state wherein current flow through the electrical load is substantially undisturbed;

a telemetry means for receiving user input signals to determine the operating status of the switching device and coupled electrical load;

a controller means for receiving the switching device status signals from the radio receiver means and for switching the switching device between is first and second states in a predetermined sequence;

a power supply means, coupled to the AC source for supplying low voltage, direct current to the controller and radio receiver means;

isolation means for electrically isolating the user controls from the AC source, wherein the isolation means includes telemetry means for coupling the user control signals to the controller means.

According to another aspect of the invention, there is further provided an method for operating an electrical load adapted to be coupled to an AC source for supplying an AC signal, operable in a wet environment, comprising:

an interconnection means adapted to be coupled to an AC source and electrical load, wherein the interconnection means allows for plug and receptacle connection to the AC source and electrical load, respectively;

a switching device adapted to be coupled in series with the interconnection means, wherein the switching device is operable in either a first state wherein significant current flow through the electrical load is prevented or a second state wherein current flow through the electrical load is substantially undisturbed;

a telemetry means for receiving user input signals to determine the operating status of the switching device and coupled electrical load;

a controller means for receiving the switching device status signals from the radio receiver means and for switching the switching device between its first and second states in a predetermined sequence;

a power supply means, coupled to the AC source for supplying low voltage, direct current to the controller and radio receiver means;

isolation means for electrically isolating the user input signals from the AC source, wherein the isolation means includes telemetry means for coupling user input signals to the controller means;

the method comprising the steps of:

(a) switching the switching device to its first state;

(b) waiting for a telemetry data;

(c) detecting zero crossing point of AC input signal;

(d) generating a delay; and

(e) switching the switching device to its second state.

Other advantages, objects and features of the present invention will be readily apparent to those skilled in the art from a review of the following detailed description of the preferred embodiment in conjunction with the accompanying drawings and claims.

### BRIEF DESCRIPTION OF THE DRAWINGS

The embodiments of the invention will now be described with reference to the accompanying drawings, in which;

FIG. 1 is a schematic of the prior art showing a cut-away view of a typical hydromassage bathing appliance, detailing the installation of a pneumatically controlled switch and water circulation pump.

FIG. 2 is a schematic of the prior art showing a cut-away view of a typical hydromassage bathing appliance, detailing the installation of an electrically isolated control system coupled to a water circulation pump.

FIG. 3 is a schematic of one embodiment of the present invention.

FIG. 4 is a flow chart illustrating the receiving of telemetry data and control of switching device sequence of the controller of the present invention.

With respect to the above drawings, similar references are used in different Figures to denote similar components.

### DETAILED DESCRIPTION OF THE INVENTION

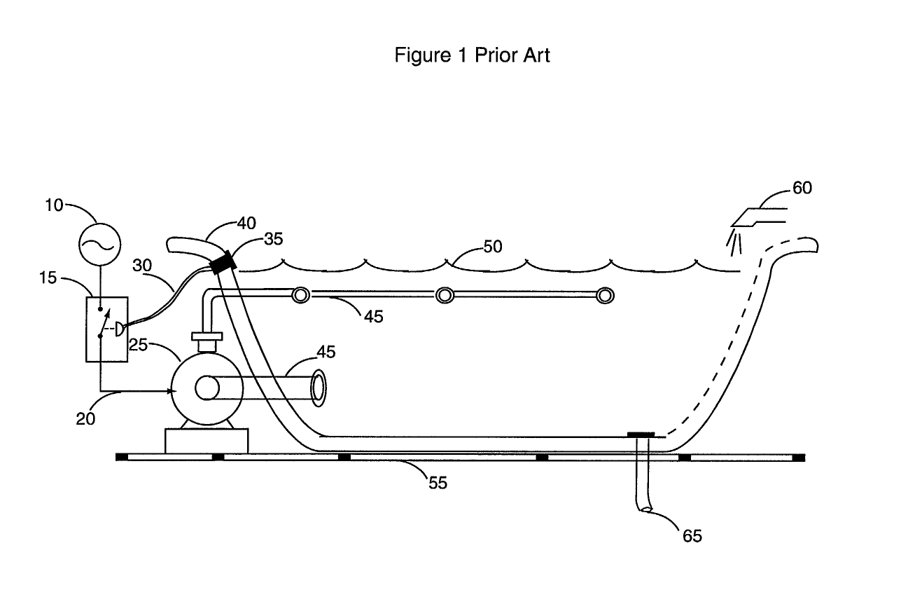

Referring to FIG. 1, there is shown an embodiment of a prior art pneumatically coupled user actuator and switch. A typical hydromassage bathing appliance 40 is shown being filled with water 60 to a typical operating level 50. The water drain 65 is assumed to be closed. The bath 40 sits of a flooring platform 55. An electrical load in the form of a water pump and motor assembly 25 and circulation plumbing 45 completes the bath assembly. An AC source 10 is series coupled to a pneumatically controlled switch 15 which in turn, supplies power 20 to pump and motor assembly 25. A user control “air bellows switch” 35 is connected to one end of hose 30, the other end of hose 30 being coupled to pneumatic air switch 15. When bather presses air bellows switch 35, air is pressurised in hose 30 and activates pneumatic switch 15, which changes state, closing the switch and connecting AC source 10 to pump and motor assembly 25. Similarly, pressing air bellows switch 35 a second time will cause switch 15 to change state disconnecting AC source 10 from pump and motor assembly 25, causing water to stop circulating in bath 40. Supplying a sufficient length of hose 30 with ambient room air, provides a sufficient electrical isolation barrier for the bather immersed in bath water 50 to the AC source 10.

A drawback with pneumatic control devices is that they are difficult to design with sufficient control features such as variable speed functions or user displays.

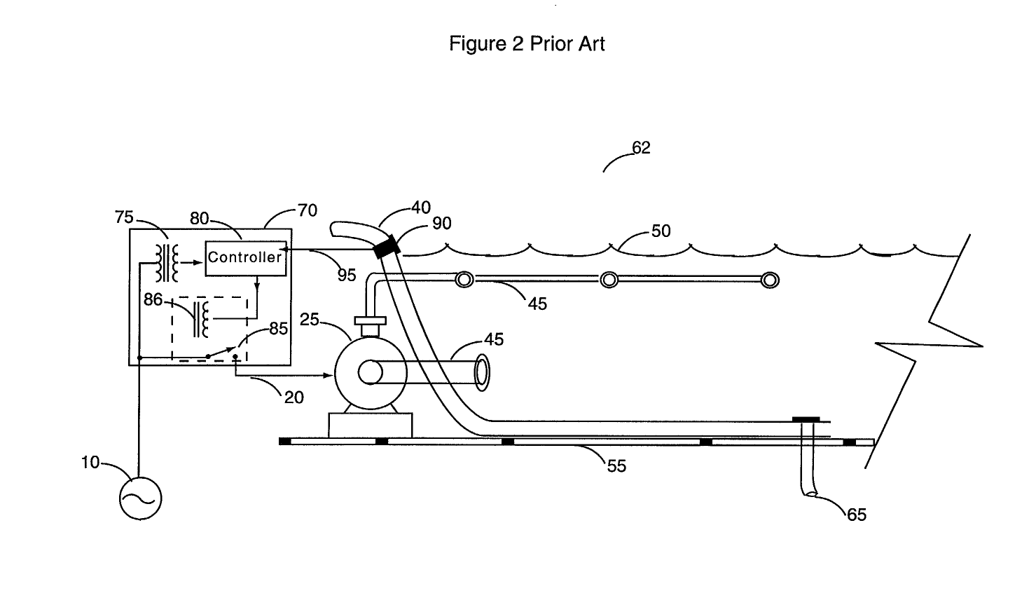

Referring now to FIG. 2, there is shown a second embodiment of a prior art electrically isolated control system 70, adapted to be coupled to a bathing appliance of similar construction to that detailed in FIG. 1, above. An AC source 10 is series coupled to one side of relay switch 85. The other side of relay switch 85 is coupled to pump and motor assembly 25 through cable 20. AC source 10 is also coupled to step-down, isolation transformer 75, providing low-voltage, isolated power to controller means 80. A user electrical push button 90 is mounted to bathing appliance 40 in such a manner that a user immersed in bath water 52 could activate switch 90. Switch 90 is coupled to controller means 80 via wire cable assembly 95. Activating control switch 90 sends a user input signal to controller means 80 through cable 95, causing controller 80 to activate relay coil 86. Activation of relay coil 86 causes relay switch 85 to close, thus connecting AC source 10 to pump and motor assembly 25 through power cable 20. Electrical shock hazard protection of a user immersed in bath water 50 is provided by special construction methods of step-down, isolation transformer 75 and relay unit (comprising 85 and 86). A reader skilled in the art will understand electrical isolation means as applied to transformers, relays and similar components.

Drawbacks to electrically isolated control systems include:

(a) the use of electrical cables between the AC mains supply, electrical load(s);

(b) the use of signal interface cables between the button and controller means;

(c) difficult to access cables and control units after installation; and

(d) the requirements of isolation transformer and other electrical isolation means to protect the user from electric shock.

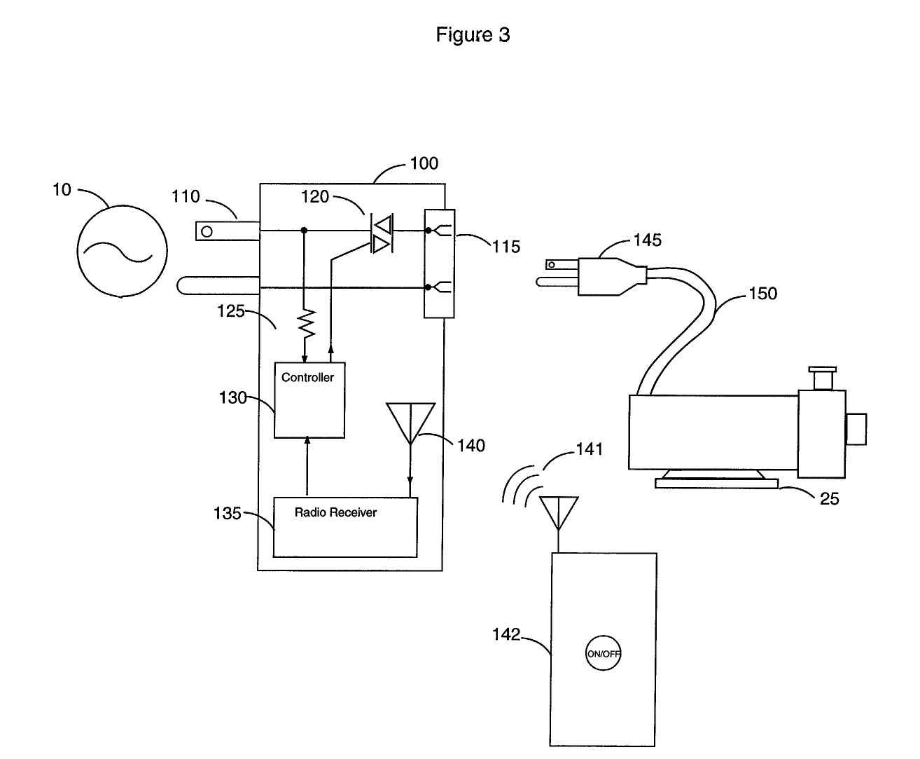

Now referring to FIG. 3, there is shown an embodiment of the present invention 100. There are numerous advantages of the present invention 100 in that it does not require persons skilled in the art to install it, there are no power or interface cable necessary for interconnection and it is not necessary to electrical isolation between the control system 100 and the bather due to the use of telemetry user signals detected by antenna 140 and radio receiver 135.

The present invention 100 includes an interconnection means (comprising 110 and 115) which are adapted to allow AC source 10 to be coupled to input connector set 1 10 and likewise, electrical load power supply cord 145 to be coupled to output connector set 115. A person skilled in the art will recognise that interconnection means 110 and 115 comprise a NEMA (National Electrical Manufacturers Association) power plug assembly for connection to AC supply sources in North America, with a nominal voltage of 120 Volts AC and nominal current rating of 15 Amperes. For higher voltages, currents or other parts of the World, alternate interconnection means could be adapted to those requirements without deviating from the scope of the present invention.

A switching device 120 is adapted to be coupled in series with the input connector set 110 and the output connector set 115. In the preferred embodiment shown in FIG. 3, the switching device 120 is a triac, although a person skilled in the art would realise that any switching device, such as a relay or other thyristor arrangement, could be substituted without departing from the scope of the present invention. A series resistor 125 is coupled to the input connector set 110 in such a manner that a when controller 100 is connected to an AC source 10, one side of resistor 125 becomes energised. The opposite side of resistor 125 is coupled to controller means 130 in such a manner as to provide a low-voltage power supply circuit to operate the logic devices of controller means 130. A person skilled in the art would realise that a step-down transformer, capacitor or other means could be substituted for resistor 125. Controller means 130 is coupled to switching device 120 in such a manner as to allow controller means 130 to operate the switching device in either a first state wherein significant current flow through the electrical load 145 is prevented or a second state wherein current flow through the electrical load is substantially undisturbed. A radio receiver 135 and antenna means 140 are adapted to be coupled to receive telemetry signals 141 broadcast from some form of user control device 142.

Prior to operation, the control system 100 is connected to AC source 10, using interconnection means 110. Electrical load example 25 is connected to interconnection means 115 using power cord 150 and plug 145. This completes the installation of control system 100 and allows safe and reliable installation of electrical loads within the current carrying capacity of the control system 100.

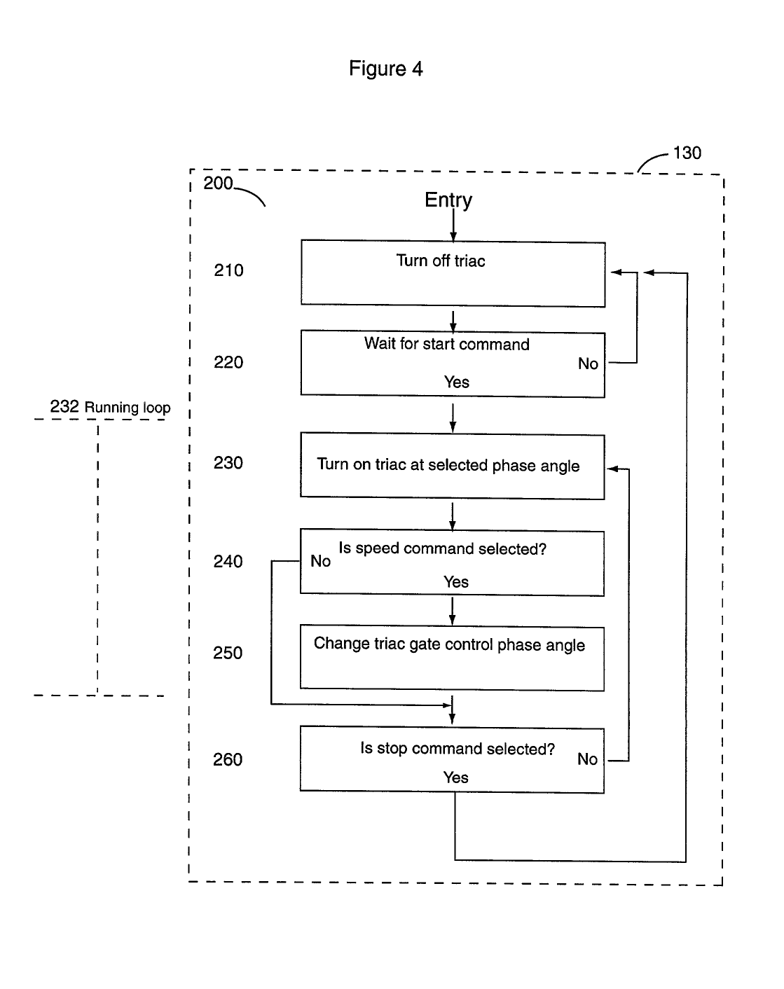

During operation, controller means 130 monitors output of radio receiver 135 for telemetry signals 141 generated by user control 142 and received at antenna 140. Controller means 130 executes control sequence outlined in FIG. 4 and determines which state switching device 120 should be in, allowing electrical load 25 to either remain at standby or be operative.

Utilising a radio receiver 135 and antenna 140 provides sufficient electrical isolation from AC source 10 to prevent electrical shock of a user immersed in the bath water, previously discussed above.

Referring now to FIG. 4, a flow chart of the operating mode sequence 200 of controller 130 is shown. When control system 100 is connected to AC mains supply 10, entry to operating mode sequence 200 is started. Controller 130 executes step TURN OFF TRIAC 210 placing triac 120 in a first state wherein significant current flow through the electrical load is prevented. Controller 130 then advances to step WAIT FOR START COMMAND 220. If no start command is received, controller 130 will loop back to step TURN OFF TRIAC 210 until a start command is received. When a start command is received, controller advances to step TURN ON TRIAC AT SELECTED PHASE ANGLE 230. A reader skilled in the art will recognise that this step involves the creation of a phase angle delay based on the zero crossing reference of the AC mains 10 developed across resistor 125 as outlined in FIG. 3 above. Where the switching device 120 is a relay, the phase angle delay will be approximately 0 electrical degrees. Where the switching device is a triac as shown in the preferred embodiment, FIG. 3, the phase angle delay may be any value within a suitable range for operating the connected electrical load 25. Once triac is turned on in step 230, the controller 130 will advance to step IS SPEED COMMAND SELECTED? 240. For control systems 130 that have no speed requirements, step 240 and 250 will be skipped. For control systems 130 that are equipped to operate using phase angle delay control for adjusting speed or effective voltage to the connected load 25, a loop in control sequence 200 is formed. If a speed command has not been selected, controller 130 advances to step IS STOP COMMAND SELECTED? 260. If no stop command is selected, controller 130 advances to step TURN ON TRIAC AT SELECTED PHASE ANGLE 230 and the RUNNING LOOP 232 is continued. If the stop command is selected at step 260, the controller advances to step TURN OFF TRIAC 210, turning off electrical load 25 and waits for further input. If a speed command was selected in step 240, the controller 130 advances to step CHANGE TRIAC GATE CONTROL PHASE ANGLE 250, whereupon step IS STOP COMMAND SELECTED? 260 is executed as noted above. A person skilled in the art will be familiar with the execution of controller, sequence steps as described above, including the use of logic decision branches, phase angle control and running loops.

Numerous modifications, variations and adaptations may be made to the particular embodiments of the invention described above without departing from the scope of the invention, which is defined in the claims.

What is claim is:

1. An apparatus operable in a wet environment for controlling the flow of electrical current to an electrical load, adapted to be coupled to an AC source for supplying an AC signal, comprising:
a switching device coupled to the electrical load, the switching device being operative in either a first state wherein significant current flow through the load is prevented or a second state wherein current flow through the load is substantially undisturbed;
an interconnection means adapted to be coupled to an AC source and electrical load, wherein the interconnection means allow for plug and receptacle connection to the AC source and electrical load, respectively;
a telemetry means for receiving user input signals from a transmitter means to determine the operating status of the switching device;
a controller means for receiving the switching device status signals from the radio receiver means and for switching the switching device between its first and second states in a predetermined sequence;
a power supply means, adapted to be coupled to the AC source for supplying low voltage, direct current to the controller and radio receiver means; and
isolation means for electrically isolating the user input signals from the AC source, wherein the isolation means includes telemetry means for coupling user input signals to the controller means.

2. An apparatus as defined in claim 1, wherein the switching device includes a relay.

3. An apparatus as defined in claim 1, wherein the switching device includes a thyristor arrangement.

4. An apparatus as defined in claim 1, wherein the switching device includes a triac.

5. An apparatus as defined in claim 1, wherein the interconnection means includes an interconnection plug and receptacle for connection to the AC mains interconnection system utilised in a country where the herein apparatus is to be installed.

6. An apparatus as defined in claim 1, wherein the interconnection means includes a NEMA plug and receptacle set.

7. An apparatus as defined in claim 1, wherein the telemetry means includes a radio receiver and antenna.

8. An apparatus as defined in claim 1, wherein the telemetry means includes an modulated infrared light receiver.

9. An apparatus as defined in claim 1, wherein the telemetry means includes an optical modulation receiver.

10. An apparatus as defined in claim 1, wherein the controller means includes a microcontroller device.

11. An apparatus as defined in claim 1, wherein the power supply means includes a step-down, transformer.

12. An apparatus as defined in claim 1, wherein the power supply means includes a dropping resistor network.

13. An apparatus as defined in claim 1, wherein the power supply means includes a voltage dropping capacitor network.

14. A method for controlling the flow of electrical current to an electrical load, adapted to be coupled to an AC source for supplying an AC signal, operable in a wet environment, comprising:
a switching device coupled to the electrical load, the switching device being operative in either a first state wherein significant current flow through the load is prevented or a second state wherein current flow through the load is substantially undisturbed;
an interconnection means adapted to be coupled to an AC source and electrical load, wherein the interconnection means allow for plug and receptacle connection to the AC source and electrical load, respectively;
a telemetry means for receiving user input signals from a transmitter means to determine the operating status of the switching device;
a controller means for receiving the switching device status signals from the radio receiver means and for switching the switching device between its first and second states in a predetermined sequence;
a power supply means, adapted to be coupled to the AC source for supplying low voltage, direct current to the controller and radio receiver means; and
isolation means for electrically isolating the user input signals from the AC source, wherein the isolation means includes telemetry means for coupling user input signals to the controller means;
the method comprising the steps of:
(a) switching the switching device to its first state;
(b) waiting for a telemetry data;
(c) detecting zero crossing point of AC input signal;
(d) generating a delay; and
(e) switching the switching device to its second state.
